(19) United States
(12) Patent Application Publication
(10) Pub. No.: US 2023/0118139 A1
(43) Pub. Date: Apr. 20, 2023

(54) CEMENT SIDING CUTTER

(71) Applicant: D-CUT PRODUCTS, INC., OAK BROOK, IL (US)

(72) Inventor: Charlie ZHANG, Oak Brook, IL (US)

(73) Assignee: D-CUT PRODUCTS, INC., OAK BROOK, IL (US)

(21) Appl. No.: 17/502,981

(22) Filed: Oct. 15, 2021

(51) Int. Cl. B28D 7/04; B28D 1/22

(52) U.S. Cl. CPC B28D 7/043; B28D 1/228

(57) ABSTRACT

A cutting tool includes a base having a table surface. The table surface has a circular turntable and a cutting platform connected with respect to the circular turntable. The cutting platform is rotatable about an axis of the circular turntable. At least one connector releasably locks the cutting platform to the turntable at a number of positions about the axis. A blade housing and blade are suspended above the cutting platform. A handle is attached to the cutting tool to raise and lower the blade. The handle is rotatably supported by a cam integrated with the blade housing.

### BACKGROUND OF THE INVENTION

### Field of the Invention

This invention relates generally to a cutting tool and, more particularly, to a cutting tool for cutting building materials, specifically cement siding materials.

### Description of Prior Art

Users cut building materials, such as those used for siding options, in a variety of ways to fit in and around an exterior of residential and/or commercial buildings. Siding pieces may need to be cut horizontally, vertically, and/or at various angles to properly align the siding to fit a particular layout or design.

Regardless of the type of installation, all types of siding options often need to be cut in some capacity prior to or during installation. Common siding options include vinyl, wood, brick, stone, stucco, and cement board. Different tools and techniques are used to install siding depending on the type of siding desired. For board siding such as vinyl, wood and cement, different tools of varying cutting strengths are used to cut and modify the board pieces.

Cement board siding has grown increasingly popular as a siding option for its durability and aesthetics. Cement board siding may come in a variety of compositions, but such siding customarily is made up of a combination of cement, wood fiber, and other additives. Compared to traditional board siding options (wood, vinyl, etc.) cement board is more durable, while maintaining a “wood look” is easily accomplished in a wide variety of colors, styles, sizes and finishes. As the demand for cement board siding continues, improved cement siding cutters are desired.

### SUMMARY OF THE INVENTION

The invention generally relates to a cement siding cutter. The general object of the invention can be attained, at least in part, through a cutting tool. The cutting tool includes a base having a table surface. The table surface includes a circular turntable. The cutting tool also includes a cutting platform connected with respect to the circular turntable. The cutting platform is rotatable about an axis of the circular turntable. At least one connector releasably locks the cutting platform to the turntable at a number of positions about the axis.

The cutting tool also includes a blade housing with a blade suspended above the cutting platform. A handle raises and lowers the blade. The handle is rotatably supported by a cam integrated with the blade housing. A guide bar is also included as a part of the cutting tool. The guide bar passes over the cutting platform.

A slide cam is mounted on the table surface of the cutting tool. The slide cam includes a slide cam shaft and a slide cam mount. The guide bar is mounted to the slide cam mount. The guide bar is slidable in a linear direction on the slide cam mount. The guide bar is releasably locked with respect to the slide cam mount at a plurality of positions. The slide cam mount is slidable in a linear direction on the slide cam shaft. The slide cam mount is releasably locked with respect to the slide cam shaft at a plurality of positions. The linear direction on the slide cam mount is perpendicular to the linear direction on the slide cam shaft.

The blade housing and the blade of the cutting tool can be configured as one piece if desired. Additionally, the cutting platform is rotatable about the axis of the circular turntable from a first stop to a second stop. The cutting platform also includes a reinforcement bar connected to the handle. The reinforcement bar is rotatably connected to the circular turntable via at least one cam.

The general object of the invention can also be attained, at least in part, through a cutting tool with a base having a table surface and a circular turntable. A cutting platform is connected with respect to the circular turntable. The cutting platform is rotatable about an axis of the circular turntable from a first stop to a second stop. At least one connector releasably locks the cutting platform to the turntable at a number of positions about the axis. A blade housing with a blade is suspended above the cutting platform and a handle raises and lowers the blade. The handle is rotatably supported by a cam integrated with the blade housing. The base of the cutting tool can also include a series of wheels.

The distance between the first stop and the second stop is preferably less than 360° of rotation. A guide bar is also included as part of the cutting tool. A first portion of the guide bar passes over the cutting platform. A slide cam is mounted on the table surface. A second portion of the guide bar is connected to the slide cam. The guide bar is slidable in a first direction relative to the cutting surface. The guide bar is slidable in a second direction relative to the slide cam.

Other objects and advantages will be apparent to those skilled in the art from the following detailed description taken in conjunction with the appended claims and drawings.

### BRIEF DESCRIPTION OF THE DRAWINGS

FIG. 1 shows a front perspective view of a cutting tool according to one embodiment of the invention;

FIG. 2 shows a front perspective view of the cutting tool according to the embodiment shown in FIG. 1;

FIG. 3 shows a top view of the cutting tool according to the embodiment shown in FIG. 1;

FIG. 4 shows an enlarged, partial perspective view of the cutting tool according to the embodiment shown in FIG. 1;

FIG. 5 shows an enlarged, partial rear perspective view of the cutting tool according to the embodiment shown in FIG. 1;

FIG. 6 shows a side cross-sectional view of the cutting tool according to the embodiment shown in FIG. 1;

FIG. 7 shows a side view of the cutting tool according to one embodiment of the invention;

FIG. 8 shows a rear view of the cutting tool according to the embodiment shown in FIG. 7;

FIG. 9 shows a top view of the cutting tool according to the embodiment shown in FIG. 7;

FIG. 10 shows a perspective view of the cutting tool according to the embodiment shown in FIG. 7;

FIG. 11 shows a top perspective view of the cutting tool according to the embodiment shown in FIG. 7; and

FIG. 12 shows a top perspective view of the cutting tool according to the embodiment shown in FIG. 7.

### DETAILED DESCRIPTION OF THE INVENTION

The present invention provides a cutting tool preferably used to cut building materials, particularly siding materials, such as cement, vinyl and wood siding. As used herein, “building material” refers to a sheet or plank of building material, such as baseboards, crown molding, chair rail molding, wood flooring, laminate flooring, composite flooring, vinyl flooring, cement siding, vinyl siding, wood siding, vinyl composition tile, dimensional lumber or similar materials, including, but not limited to, one or more combinations of wood, cement, fiber, vinyl, concrete, rubber, plastic and/or other materials that may or may not include a laminated layer.

The cutting tool is preferably capable of cutting building materials at a plurality of angles to a table surface. The cutting tool has a rotatable cutting head and cutting platform particularly useful in making angular cuts in cement siding board such as those required for roof pitches. The cutting tool also includes an adjustable handle for easy operation of the cutting tool as well as convenience for moving and storing the cutting tool. The cutting tool preferably makes straight cuts both lengthwise and widthwise on materials. The cutting tool of this invention is also capable of cutting building materials at a wide range of angles in a horizontal plane with the use of a circular turntable.

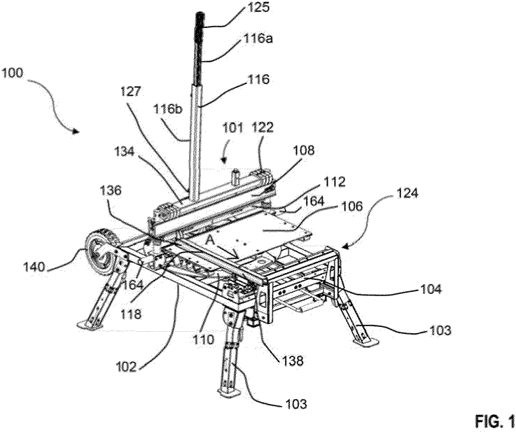

FIG. 1 shows a cutting tool 100 that includes a base 102 and a table surface 104 with a cutting platform 106 atop the table surface 104. The cutting platform 106 connects to a cutting head 101 that includes a blade housing 108 with a blade 112, and a handle 116. The base 102 includes a rectangular base that provides stability for the cutting tool 100, however the base 102 is not limited to this shape and may comprise any shape that provides stable support for the cutting tool 100. The base 102 may be formed of steel, aluminum or another material with durable qualities capable of withstanding the force required to cut the building materials. In this embodiment, the base 102 also includes a plurality of wheels 140 for moving the tool 100. The base 102 is stabilized by a series of legs 103. The legs 103 are preferably retractable so that the wheels 140 may be used to move or store the cutting tool 100.

As shown in FIG. 1, the table surface 104 is connected to at least one of the cutting platform 106 or the base 102 and supports a building material to be cut. The cutting head 101 is attached to the table surface 104 of the cutting tool 100 by a circular turntable 110. The circular turntable 110 is preferably integrated with the table surface 104 on the base 102. As such, the cutting platform 106 is also connected to the circular turntable 110 by way of the cutting head 101.

FIGS. 1-3 also show a reinforcement bar 134 extending between the supports 109, and at least one cam 122 mounted to the reinforcement bar 134. The handle 116 is attached to the reinforcement bar 134 to assist a user to rotate the reinforcement bar 134 and the cam 122. This allows the handle 116 to rotate fully from an open position to a closed position and to prevent the handle 116 from contacting the base 102 when the handle 116 is depressed to make a cut.

A piece of building material (preferably cement siding) can be placed on the cutting platform 106 and cut with the blade 112 by depressing the handle 116. The handle 116 includes a hand grip 125 for the user to manually grab or engage the handle 116. The length of the handle 116 is adjustable for easy operation for the user, as well as for moving and storing the cutting tool 100. The handle 116 includes a handle insert 116a and a handle sleeve 116b. The handle insert 116a is connected to the hand grip 125. The handle sleeve 116b is connected to the reinforcement bar 134. The insert 116a is slidable at various lengths inside the sleeve 116b. Releasable handle connectors 127 are positioned along the handle 116 to secure and release the handle 116 to adjust the length. The releasable handle connectors 127 are preferably threaded into a portion of the handle 116 where tightening of the connectors 127 puts pressure on the insert and sleeve 116a, 116b to lock the handle length in place, and wherein loosening of the connectors 127 releases the pressure so that the length of the handle may be modified. The length of the handle may be adjusted according to other known adjustment means as well.

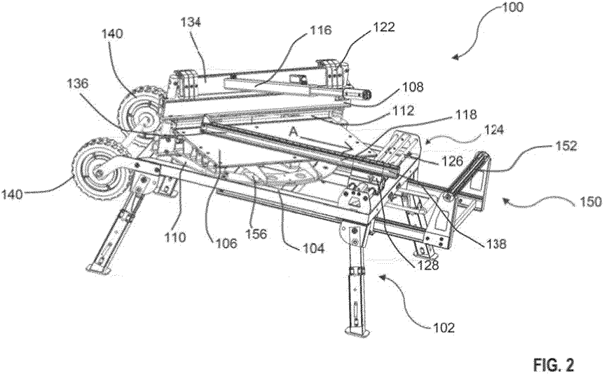

The reinforcement bar 134 includes the plurality of cams 122 for connecting the handle 116 to the cutting head 101. Each cam 122 rotates when the handle 116 moves. The cutting tool of this invention starts in an open position (FIG. 1). In the open position, the blade housing 108 and the blade 112 are upward where the cam(s) 122 contacts the blade housing 108 at a relatively small radius, providing an opening between the blade 112 and the base 102. A piece of material to be cut is placed onto the table surface 104 and through the opening formed between the blade 112 and the cutting platform 106. To cut the material, the handle 116 is lowered to rotate the cam 122. By rotating the cam 122, a gradually increasing radius of an outer edge of the cam 122 pushes the blade housing 108 and blade 112 downward through the material until a large radius of the cam 122 contacts the blade housing 108 and the blade 112 contacts a blade stop thereby severing the material. Increasing the radius of the cam forces the blade housing 108 downwards from the open position to a closed position (FIG. 2). The resulting cut is optimally free of splinters and a resulting cut end of the material is otherwise clean and straight.

The cutting platform 106 preferably includes a textured or a high friction, non-slip surface that prevents the building material from slipping or moving during the cutting process. The table surface 104 is preferably made of lightweight and durable materials, such as plastic, rubber, metal and/or composite materials, but may be made of any material capable of supporting the building materials and withstanding the cutting force generated by the cutting tool 100. The cutting head 101 is preferably manufactured of steel but may comprise any material or materials capable of withstanding the force required to push the blade through the building material. The blade 112 is preferably made of tungsten.

FIGS. 1-4 show that the cutting tool 100 further includes a guide bar 118 positioned on the table surface 104. The guide bar 118 can be used to align the building material at a range of angles, on a horizontal plane, to the cutting platform 106. The guide bar 118 can be held in place to a desired position across the table surface by a slide cam 124 mounted on the table surface 104.

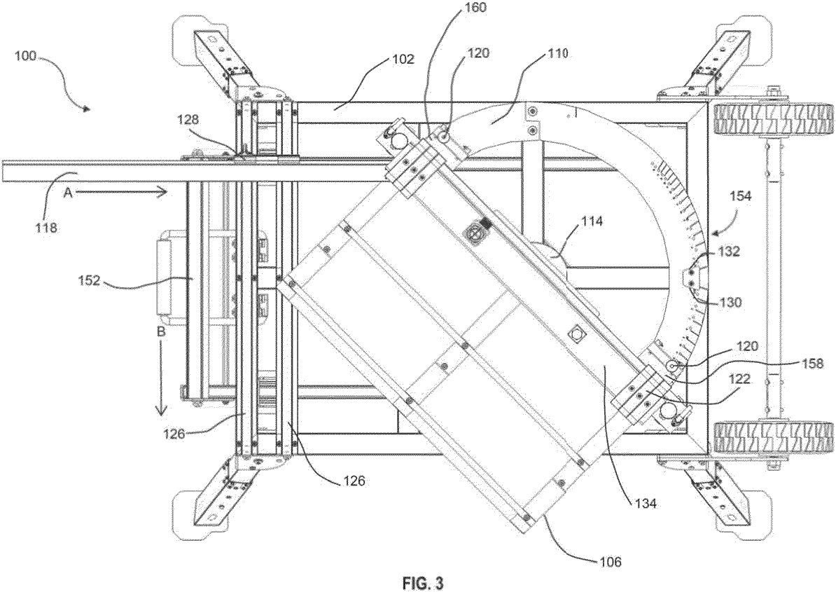

FIG. 2 shows the cutting tool 100 where the cutting platform 106 and the cutting head 101 have been rotated about the circular turntable 110. The cutting head 101 can be rotated by the user to cut a piece of material at a variety of different angular positions. In turn, the cutting platform 106 can also be rotated along with the cutting head 101. An underside of the cutting platform 106 includes a platform guide 156 that stabilizes the cutting platform 106 on the circular turntable 110 when the cutting platform 106 is rotated. The platform guide 156 glides along the turntable 110 as the cutting platform 106 is rotated from an axis 114 (shown later in FIG. 3) of the turntable 110.

The guide bar 118 is mounted to the slide cam 124 so that the guide bar 118 can remain stationary (if desired) as the cutting heat 101 and cutting platform 106 are rotated. The slide cam 124 includes a slide came shaft 126 and a slide cam mount 128. The slide cam shaft 126 includes a series of bars (3 as shown in FIG. 2) that extend across a width of the base 102. The slide cam mount 128 is mounted to the bars of the slide cam shaft 126 so that the slide cam mount 128 is slidable across the slide cam shaft 126 down the width of the base 102 in the direction marked with arrow B (shown in FIG. 3). The slide cam mount 128 can include a releasable bolt or other form of suitable connection that can be tightened and loosened to either easily move the slide cam mount or hold it in place on the shaft.

The slide cam mount 128 holds a second portion 138 of the guide bar 118, while a first portion 136 of the guide bar is positioned over the cutting platform 106. The guide bar 118 is mounted to the slide cam mount 128 so that the guide bar 118 is slidable through the slide cam mount 128 down a length of the base 102 in the direction marked with arrow A (shown in FIGS. 2-3). The slide cam mount 128 can also include a releasable bolt or other form of suitable connection that can be tightened and loosened to either easily move the guide bar or hold it in place on the mount.

Depending on the desired angle and position of the cutting platform and blade for cutting a piece of material (as well as for the size of the piece of material), the cutting tool 100 also includes a base extension 150. The base extension 150 includes a slidable extension piece that can glide to a desired length past the slide cam 124, therefore lengthening the surface area of the cutting tool. The base extension 150 is especially helpful when a long piece of material (such as a siding piece) is needed to be cut. The base extension 150 helps hold the material steady on the cutting tool 100. The base extension 150 preferably includes a stabilization bar 152 that is arranged to be on the same, or substantially similar, vertical plane as the cutting platform 106. The stabilization bar 152 is preferably attached to the base extension 150 so that the bar 152 is freely rotatable, thus allowing for streamlined movements if/when a piece of material is slid back and forth across the platform of the cutting tool.

FIG. 3 shows a top view of the cutting tool 100. Here, an axis 114 of the turntable 110 is shown. Both the cutting head 101 and the cutting platform 106 rotate about the turntable 110 from the axis 114. Just as the cutting platform 106 includes the platform guide 156 to stabilize and smooth any rotational movement about the axis 114, the cutting head 101 also includes at least one cutting head guide 158, 160. As shown in the embodiment of FIG. 3, the cutting head 101 includes two cutting head guides, a first cutting head guide 158, and a second cutting head guide 160, one at either end of the cutting head 101, even with the turntable 110.

The cutting head guides 158, 160 provide a smooth and stabilized rotation of the cutting head 101 about the axis 114 of the turntable 110; and they also provide limits in rotation of the cutting head 101 (and in turn the cutting platform 106) about the turntable 110. That is, as the cutting head guides 158, 160 rotate along the turntable 110, each guide 158, 160 has an opportunity to contact a stop.

The circular turntable 110 includes a first stop 130 and a second stop 132. The first and second stops 130, 132 act as bumpers along the circular turntable 110 to limit the degrees of rotation of the cutting head 101 and the cutting platform 106 around the turntable 110. The stops 130, 132 are physical barriers attached to a surface of the circular turntable 110. For example, the stops 130, 132 can be a singular piece with two abutting sides (such as shown in FIG. 3). However, the stops can also be individual pieces at or along a portion of the turntable. The stops are preferably made of an impact resistant material such as rubber, plastic blends, carbon fiber, PVC, vinyl, foam, etc. that can be attached to the turntable such as by bolts, nails, glue, or other attachment means. In some embodiments the stops may be adjustable so that the stops may be moved and secured to various places on the turntable as chosen by the user.

As the cutting head 101 and platform 106 are rotated clockwise around the turntable 110, the cutting head 101 and platform 106 will eventually be halted from any further rotation as the second cutting head guide 160 contacts the second stop 132. Similarly, as the cutting head 101 and platform 106 are rotated counterclockwise around the turntable 110, the cutting head 101 and platform 106 will eventually be halted from any further rotation as the first cutting head guide 158 contacts the first stop 130. As such, the rotation of the cutting head 101 and cutting platform 106 is limited to less than 360°.

However, the cutting head 101 and platform 106 can be rotated at a wide variety of angles within 360° depending on the desired angular cut of the piece of building material. The circular turntable 110 includes a plurality of angular positions, generally represented by reference number 154. The plurality of angular positions 154 can be marked along the surface of the turntable 110 to aid the user in determining that the desired cut will be made. In order to sustain a desired angular cut, both cutting head guides 158, 160 include a connector 120 to releasably lock the cutting platform 106 and cutting head 101 to a desired position. The connectors 120 are preferably bolts or screws that can be tightened and loosened to move or stabilize the cutting head and platform to a desired position along the turntable. Other suitable materials may also be used for the connectors. In some embodiments of the invention, only one connector may be used. In other embodiments of the invention, more than two connectors may be used.

FIG. 3 also shows a top view of the guide bar 118 and the slide cam 124 layout. Depending on the position of the cutting platform 106 in relation to the cutting tool 100, and depending on the size of the material being cut, the guide bar 118 can releasably slide through the slide cam mount 128 back and forth as needed along direction A. Also depending on the position of the cutting platform 106 in relation to the cutting tool 100, and depending on the size of the material being cut, the slide cam mount 128 with the guide bar 118 can releasably slide up and down the slide cam shaft 126 back and forth as needed along direction B.

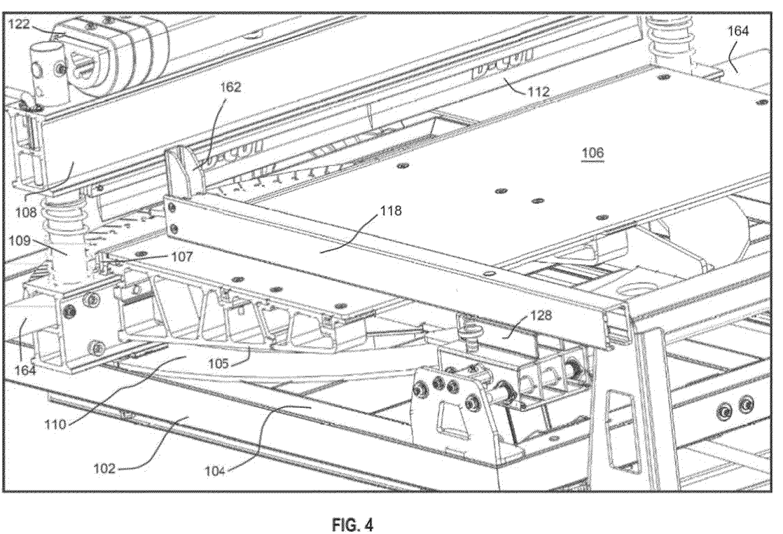

FIG. 4 shows an enlarged view of a portion of the cutting tool 100. The cutting platform 106 includes a cutting platform base 105, a blade stop 107, and at least one pair of supports 109. The blade stop 107 includes a contact element and a brace. These components of the cutting platform 106 contribute to the movement and stabilization of the linear blade 112 as the handle 116 is moved to make a cut. Such components are discussed in detail in U.S. Pat. No. 10,434,672, herein incorporated by reference.

As shown in FIG. 4, the platform base 105 is preferably angled so that the cutting platform 106 can freely move when the cutting platform 106 is rotated around the turntable 110, without the platform base 105 interacting or otherwise contacting the turntable 110. The guide bar 118 may also include a guide bar stop 162 on the first portion 136 of the guide bar. The guide bar stop 162 is vertically level with at least a portion of the blade housing 108 to aid the user in maneuvering the guide bar 118 within the slide cam mount 128.

Supports 109 are connected to the cutting head 101 and act to stabilize the cutting platform 106. The supports 109 extend generally perpendicular to a plane of the table surface 104. The supports 109 may be formed of materials such as steel or similar rigid material. In this embodiment, the supports 109 are bolts that each include a spring 117 wrapped around each bolt. The bolts are integrally threaded through a portion of the cutting head 101 to support the cutting platform 106. The supports 109 are positioned on either side of the cutting platform 106 at a width sufficient to accommodate standard sizes of material, such as but not limited to cement siding boards (such as those with a common width of 6.25 inches) or other various building materials and sizes. In other embodiments, the supports 109 can be welded to or connected with a mechanical connection, such as any additional threaded connections, to the cutting platform or connected in any other means known to one of skill in the art.

The cutting tool 100 can also include one or more handles 164 (as shown in FIGS. 1 and 4) on a base of the cutting head 101. The handle(s) 164 allow for easy operation of the cutting tool 100 by providing a surface for a user to grasp and turn the cutting head 101 and cutting platform 106 along the turntable 110 to a desired position. The cutting tool 100 preferably includes a handle 164 on either side of the cutting head 101 so that it is easy for a user to turn the head and change angles from either side of the cutting tool.

FIGS. 1-5 show the blade 112 of the cutting tool 100 may include two blades held in place to form one longer blade inside the blade housing 108. Each blade is 10-14 inches long, preferably 12.5 inches long. The total blade 112 is therefore 20-28 inches long, preferably 25 inches long. The blade is so arranged to accommodate making cuts in cement siding pieces for roof pitches. The blade preferably cuts a maximum roof pitch of 4/12 on a 6.25 inch wide cement siding board. Such boards preferably have a depth of 1.25 inches, which is an optimum depth for the blade to cut, although the blade is not limited to this particular depth. The blade is also preferably made of tungsten steel, although other suitable materials of related strength may be used.

In some embodiments of the invention, the blade is attached to the blade holder with a threaded connection. With this arrangement, the blade can be removed from the blade holder for repairs, sharpening and to select a specialty blade for any type of material.

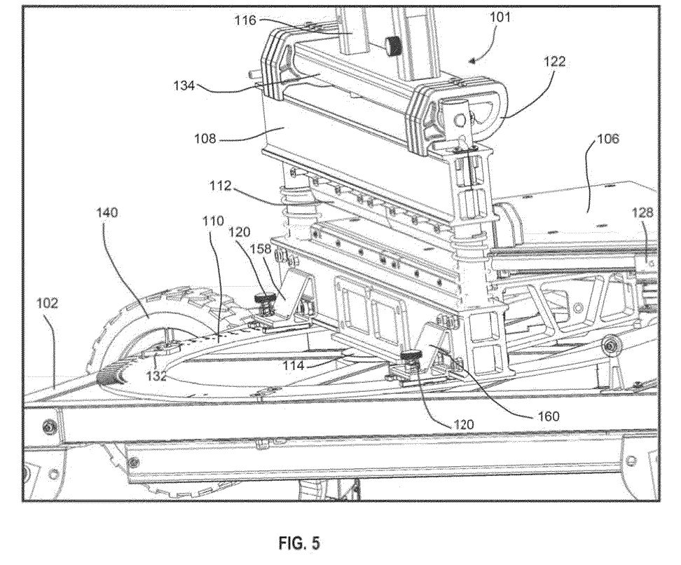

FIG. 5 shows another enlarged view of the cutting tool. As shown, the cutting head guides 158, 160 are preferably brackets, mounted to a portion of the cutting head 101 in line with the turntable 110. The cutting head guides 158, 160 can either float above the surface of the turntable 110, or can include an additional piece/underside that can smoothly glide along the turntable 110 when the connector(s) 120 are loosened.

FIG. 6 shows a cross-sectional view of the cutting tool 100. As shown, the axis 114 is positioned through the base 102, the table surface 104, the circular turntable 110, and the cutting head 101. Through these multiple layers, the axis 114 is reinforced to prevent the handle 116 from collapsing or making an insufficient cut. Due to the maneuverability of the rotational pieces of the cutting tool (axis 114, cutting head 101, cutting platform 106), the strength of the axis 114 provides additional reinforcement the cutting tool 100 needs to withstanding the pressure needed to cut material, while still providing movable (rotational) pieces.

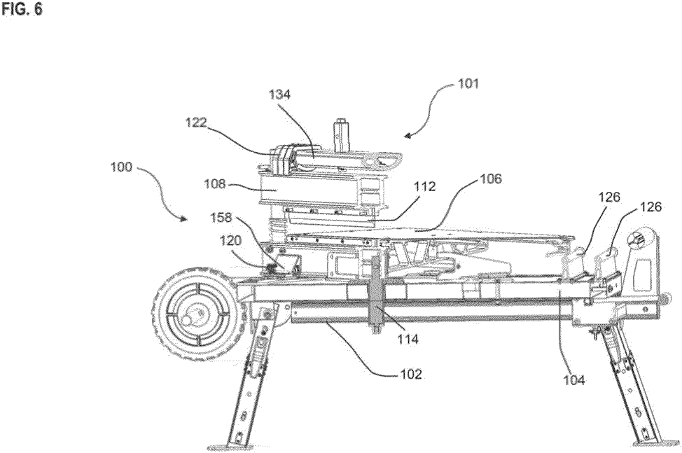

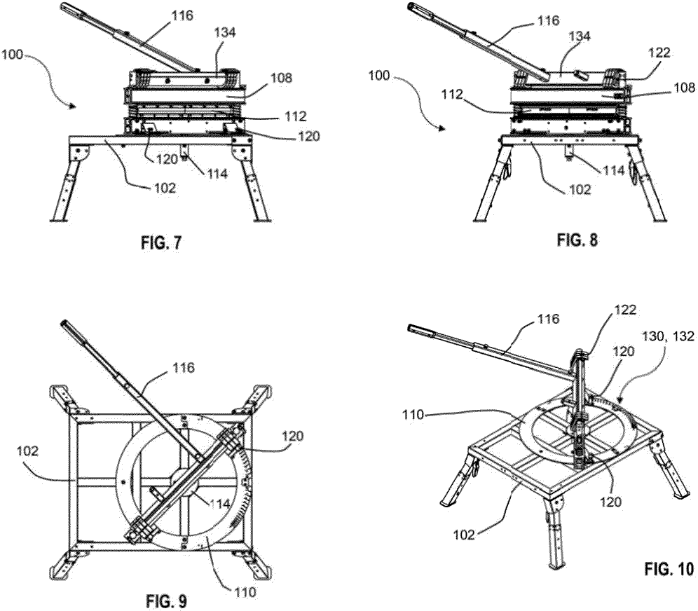

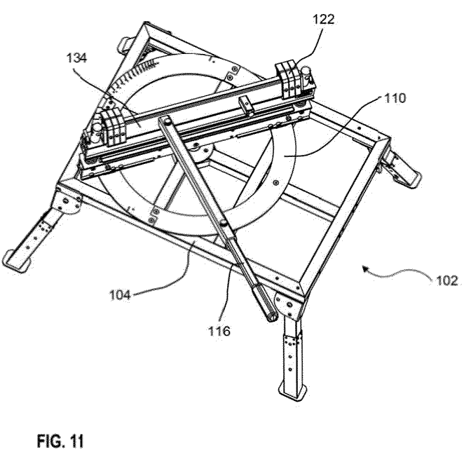

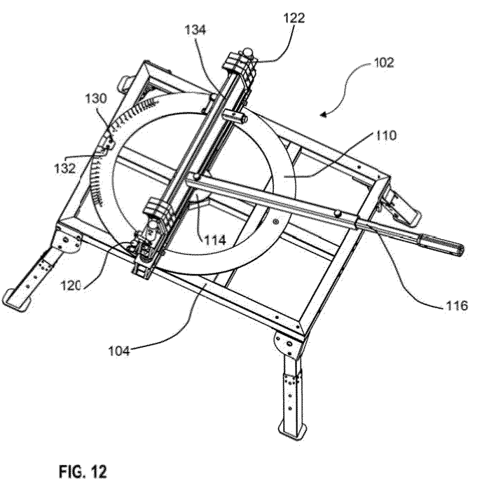

FIGS. 7-12 show components of the cutting tool 100 that can be manufactured as one piece. Mainly, the base 102, circular turntable 110, and cutting head components (blade, blade housing) can be assembled in one piece. This further provides stabilization and rigidity of the cutting tool to withstand the pressure and force needed to accomplish accurate and dust-free cuts on building materials, especially cement siding boards.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A cutting tool comprising:
a base having a table surface, wherein the table surface comprises a circular turntable;
a cutting platform connected with respect to the circular turntable, wherein the cutting platform is rotatable about an axis of the circular turntable;
at least one connector configured to releasably lock the cutting platform to the turntable at a number of positions about the axis;
a blade housing with a blade suspended above the cutting platform; and
a handle adapted to raise and lower the blade, wherein the handle is rotatably supported by a cam integrated with the blade housing.

2. The cutting tool according to claim 1 further comprising a guide bar configured to pass over the cutting platform.

3. The cutting tool according to claim 2 further comprising a slide cam mounted on the table surface.

4. The cutting tool according to claim 3 wherein the slide cam comprises a slide cam shaft and a slide cam mount.

5. The cutting tool according to claim 4 wherein the guide bar is mounted to the slide cam mount.

6. The cutting tool according to claim 5 wherein the guide bar is slidable in a linear direction on the slide cam mount.

7. The cutting tool according to claim 5 wherein the guide bar is releasably locked with respect to the slide cam mount at a plurality of positions.

8. The cutting tool according to claim 4 wherein the slide cam mount is slidable in a linear direction on the slide cam shaft.

9. The cutting tool according to claim 4 wherein the slide cam mount is releasably locked with respect to the slide cam shaft at a plurality of positions.

10. The cutting tool according to claim 8 wherein the linear direction on the slide cam mount is perpendicular to the linear direction on the slide cam shaft.

11. The cutting tool according to claim 1 wherein the blade housing and the blade are configured as one piece on the cutting tool.

12. The cutting tool according to claim 1 wherein the cutting platform is rotatable about the axis of the circular turntable from a first stop to a second stop.

13. The cutting tool according to claim 1 wherein the cutting platform further comprises a reinforcement bar connected to the handle, wherein the reinforcement bar is rotatably connected to the circular turntable via at least one cam.

14. A cutting tool comprising:
a base having a table surface, wherein the table surface comprises a circular turntable;
a cutting platform connected with respect to the circular turntable, wherein the cutting platform is rotatable about an axis of the circular turntable from a first stop to a second stop;
at least one connector configured to releasably lock the cutting platform to the turntable at a number of positions about the axis;
a blade housing with a blade suspended above the cutting platform; and
a handle adapted to raise and lower the blade, wherein the handle is rotatably supported by a cam integrated with the blade housing.

15. The cutting tool according to claim 14 wherein the distance between the first stop and the second stop is less than 360° of rotation.

16. The cutting tool according to claim 14 further comprising a guide bar, wherein a first portion of the guide bar is configured to pass over the cutting platform.

17. The cutting tool according to claim 16 further comprising a slide cam mounted on the table surface, wherein a second portion of the guide bar is connected to the slide cam.

18. The cutting tool according to claim 17 wherein the guide bar is slidable in a first direction relative to the cutting surface.

19. The cutting tool according to claim 17 wherein the guide bar is slidable in a second direction relative to the slide cam.

20. The cutting tool according to claim 14 wherein the base of the cutting tool further comprises a series of wheels.
